(19) United States
(12) Patent Application Publication
(10) Pub. No.: US 2005/0060162 A1
(43) Pub. Date: Mar. 17, 2005

(54) Systems and methods for automatic identification and hyperlinking of words or other data items and for information retrieval using hyperlinked words or data items

(76) Inventors: Farhad Mohit, Beverly Hills, CA (US); Henri Asseily, Los Angeles, CA (US); Anil Kamath, Palo Alto, CA (US); Chandramouli Mahadevan, Mountain View, CA (US); Douglas R. Chartier JR., Redwood City, CA (US)

Correspondence Address: GANZ LAW, P.C., P O BOX 2200, HILLSBORO, OR, 97123, US

(21) Appl. No.: 09/881,353

(22) Filed: Jun. 12, 2001

Related U.S. Application Data
(60) Provisional application No. 60/247,298, filed on Nov. 10, 2000.

(51) Int. Cl. G06F 17/60

(52) U.S. Cl. 705/1

(57) ABSTRACT

A method of annotating an electronic document on a computer system comprising on a first computer system, receiving an electronic document, such as a web page, with at least one key element, consisting, for example of one or more words, recognizing the key element in the document, determining the position of the key element in the document, determining an identifier for the key element from a key list, annotating the document with data corresponding to the identifier, presenting the annotated document to a user so that the user may select the annotated key element, and retrieve data or information related to the key element.

This application claims the benefit of priority to U.S. provisional patent application Ser. No. 60/247,298 filed Nov. 10, 2000, which is hereby incorporated by reference as if set forth in its entirety.

The information contained in attached Appendices A-C and in the accompanying compact disc and copy thereof are herein incorporated by reference. This information includes:

Appendix A—Example of server executable code in recognition/annotation process:
bl_annotate.pl perl script file 5 KB

Appendix B—Example of client executable code in recognition/annotation process. The following server-side components are sent by one or more servers to a client for execution in the following order on the client:

| | |
|---|---|
| buylites.js | JavaScript 1KB |
| bl_style.css | cascading stylesheet 4KB |
| bl_vb.js | visual basic script 1KB |
| bl_start.js | Javascript 1KB |

Appendix C—Example of client-side annotation and recognition code

| | |
|---|---|
| Defiler.cpp | C++ 8KB |
| GnomeIEPageBroker.cpp | C++ 5KB |
| HTMLAnnotatorProxy.cpp | C++ 5KB |
| HTMLParser.cpp | C++ 5KB |
| IEDocUtils.cpp | C++ 6KB |
| ProperNounDB.cpp | C++ 4KB |

The accompanying compact disc was created on Jun. 11, 2001.

### BACKGROUND OF THE INVENTION

Portions of the disclosure of this patent document, including the source code listings in the appendices, contain material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. Field of Invention

The present invention relates to methods and systems for automatically analyzing electronic documents and annotating “key elements”, such as predefined words, with embedded hyperlinks and/or other data. The present invention, among other things, further relates to systems and methods for retrieving information through embedded hyperlinks. In one embodiment, the retrieved information relates to products or services in the context of e-commerce.

2. Background Art

Methods for referencing to electronic documents on decentralized computer systems, in particular the Internet, commonly employ hypertext functionality. Hypertext, which may include variations such as Hypertext Markup Language (HTML) and Extensible Markup Language (XML), accomplish this referencing functionality by associating documents with a document address or Universal Record Locator (URL) “hyperlink” of a target document. Hyperlinks are commonly distinguished from other data in a document by underlining, coloring, or an image or graphic. Such methods provide efficiencies by allowing selection of a hyperlink rather than knowing and inputting document addresses manually.

However, annotating, or embedding hyperlinks into documents conventionally requires a process of manual encoding. After presentation to a user, further annotation of links and document data requires further manual editing. Hyperlinks are also limited by their static nature, corresponding only to singular, predefined URLs. Although the existing Web framework is good at linking to such static documents, documents with static links are not particularly interactive or dynamic in their ability to allow users to move from a current document to other documents with information that is contextually relevant to information on the current document, particularly where the current document does not include native hyperlinks for items of information existing on the current document. For example, a web page might have text that discusses an actor and the movies the actor has appeared in. If a referenced movie is of interest to a user, unless there is a hyperlink to information about the movie, the user must go outside the document to retrieve information about the movie. Even if a hyperlink is associated with the name of a movie, the hyperlink may not retrieve the information of most interest to the user. There is also no convenient method for automated updates of the links due to their static nature. For example, updates are desirable if the current link does not retrieve the most relevant information for the linked content element.

Considering the vast number of existing web documents, manual annotation is simply impractical. There has been a substantial need for new methods and systems for modification of existing Web documents so that information and data contextually related to the content document may be easily retrieved through the document, so that users are not limited to retrieving information through the static links native to the document.

Methods have been introduced, such as Common Gateway Interface (CGI) server-based scripting, that can dynamically annotate Web documents from an external file, including embedding of hyperlink data. In these methods documents are automatically scanned by a server-based system for data or strings against a list. Such methods have subsequently provided means to identify and embed hyperlinks without manual editing of documents. The document is dynamically annotated by the system with hyperlinks corresponding to matched list data. By employing relational database techniques, hyperlink data can be associated with key IDs that may be updated or manipulated more efficiently externally. An example of this is a search engine which dynamically processes an input query and returns results, often as a list of hyperlinks to web documents. Prior art systems include U.S. Pat. No. 6,092,074 to Rodkin, et al., which Applicants hereby incorporate by reference in its entirety for all purposes. The prior art methods teach and are dependent essentially on server-side processing for annotation, and do not use client systems, e.g., user or consumer computer systems for the annotation process. The client merely renders the annotated document through its browser system.

The prior art methods and systems use a central server system for the annotation process. If a client or content provider system must make calls to the central server for an annotated document, this results in slower processing time, slower response time, inefficient methods, and dependence on connection to a central server. Accordingly, there is a need for annotation systems and methods that can be flexibly distributed over a central server, a proxy, or client computer improving performance and allowing efficiency, reliability and expanded functionality, such as execution of machine instructions. In particular, there is a need for systems that take advantage of client-side processing to overcome the aforementioned problems.

Further, users are increasingly demanding advanced functionality in searching for expanded information, concise comparison data, and linking capability. In particular, there is a need to provide more expanded and functional results from links internal to a current document on a user's computer system. Conventional hyperlinks only directly reference static URLs. On the other hand there is a need for address “identifiers” that allow relational reference to static URLs, multiple URLs, downloadable codes, and other objects which may be dynamically referenced through an address Identifier associated with an element of content on a document. Existing annotation methods do not or inadequately have such capability.

To make e-commerce more efficient, there is also a need for systems and methods that provide dynamic annotation of web document content related to products and services. There is a further need for search engine systems that are linked to content elements annotated on a web document and allow consumers to find information about products or services related to the content element. In particular, there is a need for systems and methods that produce output in the nature of product/service-related information. There is also a need for systems and methods that present the information in an organized and sorted manner, for example, by product category listings, comparative product information, etc.

### SUMMARY OF THE INVENTION

The present invention provides systems and methods that overcome the problems in the prior art and satisfy the aforementioned needs. Among other things, the present invention satisfies the need for systems that annotate Web documents to provide expanded functionality, such as dynamic analysis and embedding of expanded information in the form of one or more hyperlinks, executable code and/or other text or objects of annotated words or strings. The present invention further satisfies the need for systems and methods for an online information retrieval system. In particular, the system automatically recognizes “Key Elements” consisting of strings of data. A Key Element may be, for example, characters, code, words, phrases or other selected items of data that exist in an electronic document, such as a web document, or other electronic file. The system uses address identifiers to annotate Key Elements, creating links to information that is contextually relevant to a Key Element. The system and methods are particularly useful for retrieval of information that is dynamically generated in response to a users selection of an annotated Key Element. Advantageously, the components of the present invention may be flexibly distributed over a networked system of computers. Among other things, this allows the system to take advantage of client-side recognition and/or annotation of Key Elements, avoiding the problems associated with systems where recognition and annotation functions occur off the client server.

The system of the present invention also advantageously allows shopping from any web document having an annotated Key Element. The web document need not necessarily relate to an online shopping service.

In addition to the foregoing, other novel methods and systems are expressly described or are contemplated herein, as will be apparent to persons skilled in the art from the teachings herein.

### BRIEF DESCRIPTION OF THE DRAWINGS

FIG. 1 shows an overview of a system that includes different computer systems in network communication.

FIG. 2 illustrates features that may be found in a computer system in the system of FIG. 1 FIG. 3 is a block diagram showing an overview of certain software components in accordance with the present invention.

FIG. 4 is an example of a Key Element Identifier List (“Key List”) in accordance with the present invention.

FIG. 5 is a diagram showing an example of a method for recognizing Key Elements for annotation in accordance with the present invention.

FIG. 6 is a flowchart representing a general overview of the Recognizer and Annotator software components in accordance with the present invention.

FIG. 7 is a flowchart providing an overview of Linking, Retrieval and Presentation functions in accordance with the present invention

FIG. 8 is a diagram showing an overview of one possible system in accordance with the present invention.

FIG. 9 is a flowchart showing an overview of a method that may be performed by the system of FIG. 8.

FIG. 10 is a diagram showing an overview of another embodiment of a system in accordance with the present invention.

FIG. 11 is a flowchart showing an overview of a method for information retrieval in accordance with the present invention.

FIG. 12 shows example features of an electronic document annotated in accordance with the present invention.

FIG. 13 shows an example of information retrieved from a selection of an annotated Key Element on the electronic document of FIG. 12.

### DETAILED DESCRIPTION OF THE INVENTION

The present invention generally relates to systems for annotating predefined content elements in an electronic document so as to associate predefined data with the predefined element. Embodiments of the present invention may be used to retrieve information related to an annotated element. Among other things, the information may include information on products and/or services related to a predefined content element. The present invention is not limited in any way by the nature of such products or services. Examples of products or services that may be searched for over a medium such as, but not limited to the Internet, include, but are not limited to, consumer products, cars, vacations, movies, music, financial and information services. In addition to business-to-consumer transactions, the present invention may be used to facilitate business-to-business transactions involving any kind of goods or services.

As a convenience, the term “product” will hereinafter be used to mean a product or service or both. Although the present invention may be described in terms of products and services, this is a convenience to facilitate the description of the present invention. The present invention is not necessarily limited to such, and may be used to annotate and retrieve information relating to non-commercial items, such as reference or educational information.

The user of certain embodiments of the present invention is typically a consumer shopping for a product, such as those mentioned above. Although the term consumer may be used herein, it is to be understood that a user, or beneficiary of the embodiments of the present invention, need not necessarily be involved in a commercial transaction.

For definitional purposes, generally, “data” means facts and beliefs about the real world; “information” is data that has been processed and formatted to support decision-making. Data may be processed to generate information. Information may also be processed to generate further information. The information that has been processed may itself be data depending on the context. “Data” or “information” includes data and/or information formatted into or as electronic files. For convenience herein, the terms “data” and “information” shall each be inclusive of both data and information, unless otherwise expressly or contextually indicated.

The systems, methods, and features of the present invention may be implemented through an Annotation and Information Retrieval System (“AIRS”), which is a system of networked computers for carrying out the present invention.

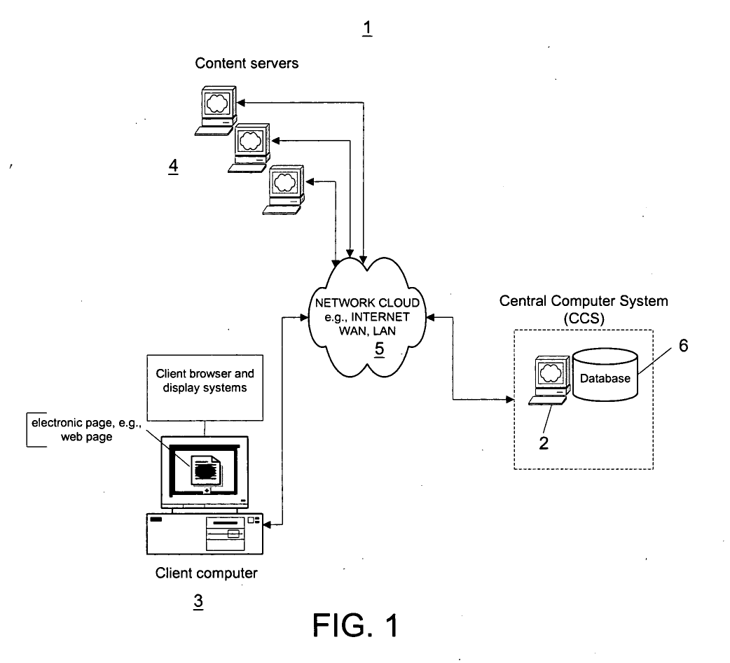

FIG. 1 shows an overview of AIRS 1, according to the present invention. The AIRS includes a Central Computer System (“CCS”) 2, one or more consumer or client computer systems 3, a plurality of content provider and/or merchant computer systems 4. As discussed in more detail elsewhere herein, the CCS 2 may be used to electronically facilitate annotation of Key Elements, communications, data transfers, and transactions between other parties, particularly consumers and merchants of products. Computer systems in AIRS 1 may be networked over LANs, WANs, VPNS, the Internet or other known network systems 5 using known protocols for such systems, including TCP/IP.

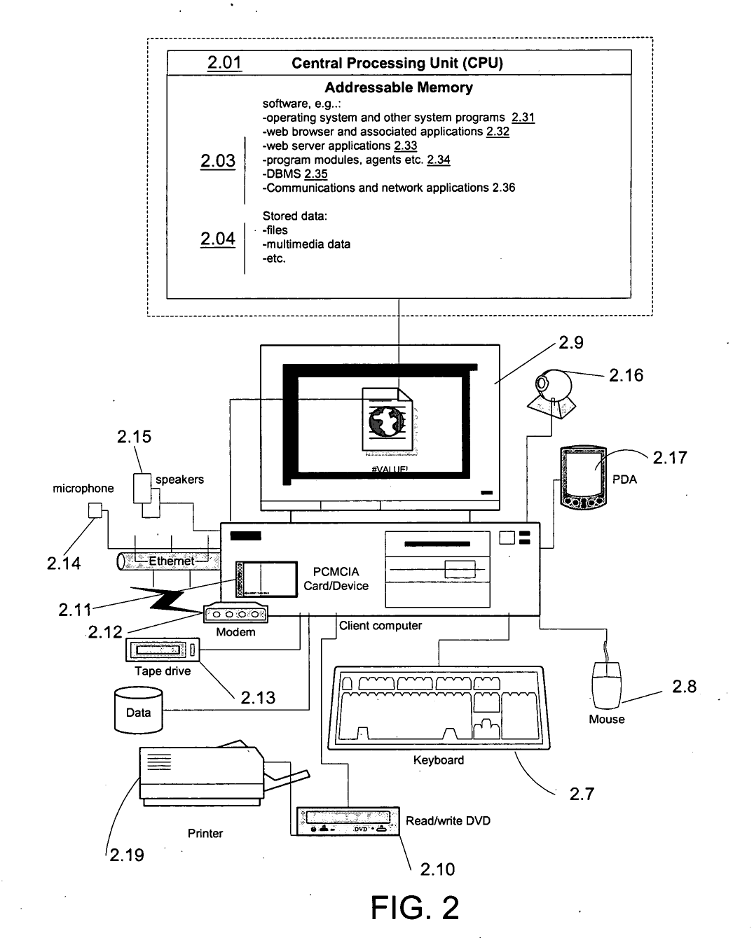

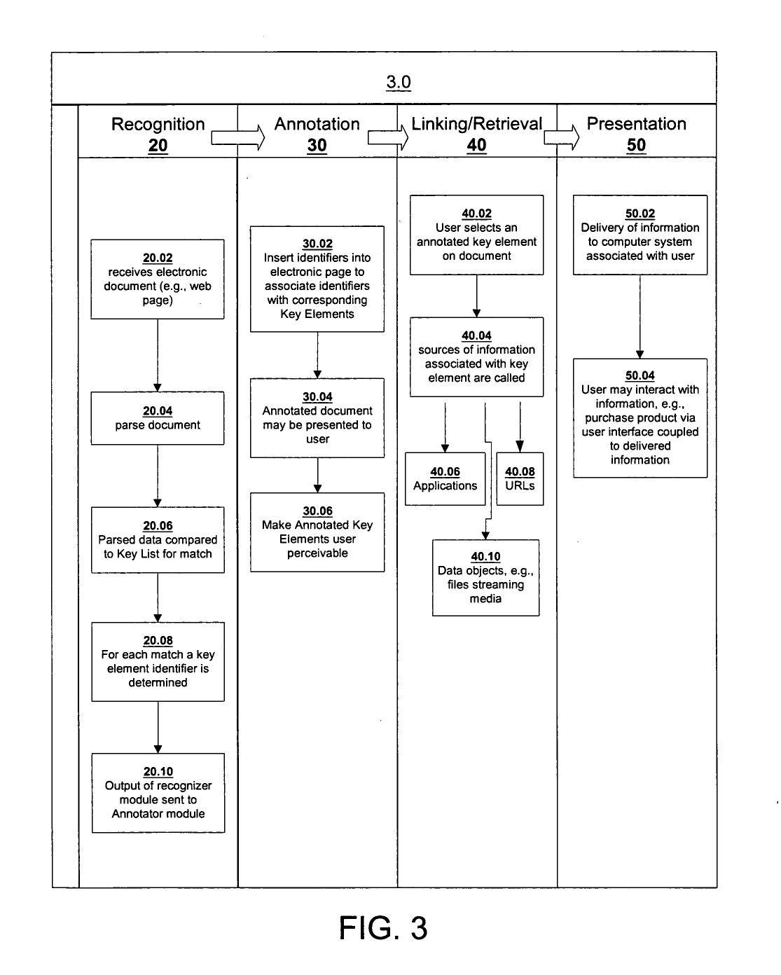

FIG. 2 illustrates features that may be typically found in a computer system 2, 3, or 4 of a participating party in AIRS 1. As used herein a “computer system” generally means a set of hardware and software components as is known in the art. A computer system 2, 3, or 4 generally includes: central processing unit (“CPU”) 2.01; memory (ROM and RAM) 2.02, e.g. a hard disk drive and associated RAM devices; programs in memory 2.03, including operating system 2.31, web browser applications 2.32 and/or web server applications 2.33, user applications or utilities 2.34, database management system (DBMS) 2.35, communications and network applications 2.36, e.g., email, and network interface systems. Memory 2.02 would also include stored data 2.04.

A computer system may include one or more of the following input/output devices: keyboard 2.7, mouse 2.8, display monitor 2.9, read/write drive 2.10 for removable media, e.g., DVD drive, PCMCIA card 2.11, modem 2.12, backup storage device 2.13, e.g., tape drive, audio capture device 2.14, e.g., microphone, audio output device 2.15, e.g., stereo speakers, still or motion image capture device, e.g., camera 2.16, and an associated computer device for data upload or download, e.g., PDA 2.17, and/or a printer 2.19.

It will be understood by persons skilled in the art, that a computer system 2, 3, or 4 may also be in the form of a Personal Digital Assistant (PDA), a wireless computer system or device capable of communications over the Internet or other network, or a computer terminal (thin client) or Internet appliance capable of such network communications.

A computer system 2, 3 or 4 in AIRS 1 may be in the form of a distributed system not under a single housing or roof but having the distributed components logically coupled and under the operational control of a participating party.

Computer systems of AIRS 1 may execute a conventional operating system 2.31, including, but not limited to, Microsoft Corporation's Windows (sm) 3.x, 95, 98, 2000, ME, NT or DOS operating systems; Linux operating systems; Sun Microsystems' Unix Solaris operating systems; IBM's AIX Solaris operating systems; SGI's IRIX Solaris operating systems, Apple OS, BE OS or other operating systems, including, but not limited to Window's CE, Palm OS, etc. for PDAs, cellular devices, web devices, or other computing devices. The possible software components of a computer system 2, 3 or 4 described herein, including operating system and application software, may reside on one or more hardware components providing addressable memory for the computer system.

Data and information may be formatted by a participating party's computer system for printing, viewing, transfer to another computer system, storage in any of many known formats, including, Adobe PDF; rich text (RTF); SGML formats including HTML, DHTML and XML; ALLAIRE Cold Fusion CFML; MICROSOFT ASP; JAVA Script MICROSOFT Word, Excel, Access; bitmap, JPEG, GIF, and other graphics file formats. It could also be presented in known audio or video formats such as WAV, MPEG, and MP3 formats.

The electronic data file may be served via known protocols, such as TCP/IP, and formatted in known formats of standardized mark up languages such as HTML and XML. Web documents generally means electronic documents that may be presented through conventional web browser applications such as the INTERNET EXPLORER series of web browser applications by Microsoft Corporation, or the NETSCAPE COMMUNICATOR series of web browsers by Netscape Communications Corporation. In a preferred embodiment, CCS 2 includes a server with a set of program modules 2.34. Certain services available to users participating through the CCS are discussed in detail in connection with the discussion of FIG. 3 and other figures. Other modules relating to technical implementation of the services associated with the program modules are as follows. The CCS may include a login module for controlling access to resources on the CCS. This module is responsible for password checking, access control, and assignment of a particular program to service the client. As used herein, “client” means a computer system that makes a request to or receives fulfillment of a request from another computer system. “Server” means a computer system that receives and/or fulfills a request from another computer system. Also, as used herein the term “computer system” may be used interchangeably with “computer”, “computing device”, “machine”, “system having computational resources” or like terms.

The CCS 2 may also include various external interface applications for converting incoming data, such as form data, to a format for communication with the respective application module or database. The CCS may also include various external service modules for obtaining information in a format required by the external service. The CCS may also include a notification module. This module handles notification and electronic mail communication with client systems. The CCS may include a database interface module. This module handles all interface requirements between application modules and the databases. For example, the database interface application manages (a) the simultaneous connections to the database such that the total number is maintained within applicable license agreements; and (b) any integrity problems in interactions between application modules and the databases. Thus, this module allows the CCS to be connected to different types of databases such as relational databases or object-oriented databases. Another function that may be included in the CCS is a consumer profile/settings module. This module receives the consumer profile and settings data sent to the CCS and performs intake operations on the data so that it may be used in other modules or assigned to databases.

The present invention contemplates that different parties may create and manage database records, input and manage data, upload files, communicate, compute data, collaborate, and exchange things with each other through their respective computer systems. The data and files may be transferred or presented to computer systems by participating parties via user interfaces developed in Standardized General Markup Languages (SGML), scripting languages, and other known languages or protocols. Such languages and protocols include MICROSOFT ASP, CFML, JAVASCRIPT, JAVA, COM, CGI, HTML, DHTML, and/or XML. To provide the foregoing functionality, the user interfaces would typically be in the nature of electronic documents such as web documents or email documents that, through appropriate computer code from such languages, are associated with databases, web servers, web browsers, file servers, network communications links, email programs, etc. The electronic documents could be static documents stored on a server or database or documents created dynamically through server function calls, for example.

Databases may be based on any number of known DBMSs, including hierarchical databases, network databases, relational databases, and object-oriented databases. Suitable DBMSs are widely available and include Oracle, Sybase, Microsoft SQL Server, open source MySQL, and DB2. One suitable database system is a relational database based on Structured Query Language (SQL). A suitable SQL database would typically include a Data Definition Language (DDL) for creation of a new database and new objects within an existing database; a Data Manipulation Language (DML) for processing existing database objects; and a Data Control Language (DCL) for administering permissions and other security-related issues. The data processing is handled by a database engine and can be accessed by various querying means, including Boolean logic evaluation, proximity calculations, and fuzzy logic evaluation. The databases of the present invention may also be custom designed, the design process and features being well within the skill of persons in the art. U.S. Pat. No. 5,983,220 of Schmitt, entitled “Database Evaluation System Supporting Intuitive Decision in Complex Multi-Attributive Domains Using Fuzzy, Hierarchical Expert Models” discloses, among other things, systems and methods for constructing and querying databases and returning and presenting results of database queries. The '220 patent is hereby incorporated by reference for all that is disclosed therewithin as if set forth herein in its entirety.

CCS 2 would usually include or otherwise be directly associated with a web server and associated database. As used herein, a web server generally refers to a computer system that hosts software that enables access by remote computer systems or terminals via the Internet or other network transport. The web server may permit one or more of the following: presentation of data and information, typically in the form of web documents or streaming media; data and information storage and transfer; and other transactions or processes that are capable through web servers. Suitable web server software is widely available and includes Apache Software Foundation's Apache Server web server; Netscape's FASTTRACK series web server, Microsoft Corporation's Internet Information Server, IBM's WebSphere, and Sun Microsystem's JAVA WEB SERVER. A web server in CCS 2 may run appropriate scripts to capture data, to process captured data, or to present processed data. A web server of CCS 2 may receive into or present data from an associated database or other data source to remote computer systems 3, 4, or other remote system, over a network 5. The data may be presented in any known format or mechanism, including HTML, XML, PDF, CFML, MICROSOFT ASP, and as graphic, audio, video and multimedia formats, and others.

FIG. 3 shows an overview 13.0 of certain applications, and certain steps associated with each application, that may be used in connection with the present invention. The program modules 2.34 include a Recognizer Module 20, an Annotator Module 30, Linking and Retrieval Module 40 and a Presentation Module 50. This combination of modules may be used in sequence to create a system for recognition, annotation, linking, retrieval and presentation. It is contemplated, however, that novel embodiments of the invention may be based on individual modules alone or on two or more modules combined with each other.

In the Recognizer Module 20, a computer system receives 20.02 an encoded document, such as a web document. The Recognizer Module parses 20.04 the document to determine whether or not the document contains one or more predefined Key Elements. The parsed data is compared 20.06 to a Key Element Identifier List having at least one identifier for a Key Element (which hereinafter may be referred to as a “Key List”) for full or partial matches to Key Elements 4.1 on the list. The “Identifier” corresponds to data to be associated with a Key Element to create an annotated Key Element. Typically, the data would designate an address, such as a URL. However, it is not limited to such, as indicated elsewhere herein.

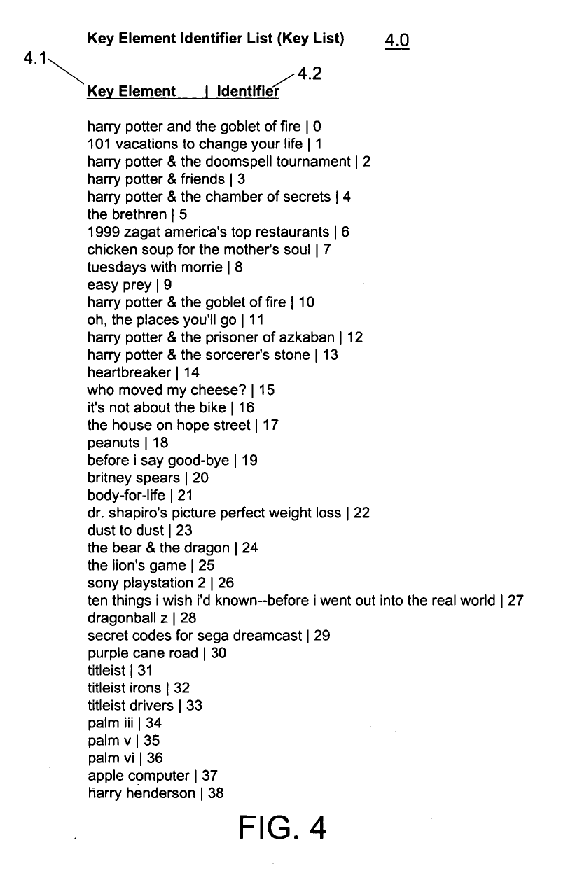

An example Key List 14.0 is presented in FIG. 4. This list includes a plurality of Key Elements in the nature of words or phrases and a corresponding identifier for each listed Key Element. For each Key Element 4.1 resulting in a match, at least one Key Element identifier 4.2 is determined 20.08 for the Key Element. The identifier address may be a URL or a code that is translatable into one or more URLs or other electronic addresses. For example, FIG. 4 shows numerical codes that would have an address in the form of at least one URL that corresponds to the code. Such addresses will typically be associated with (1) static information (for example, a web page), or (2) mechanisms to dynamically generate information. For example, the dynamically generated information could be generated from a search engine or executed software program associated with an address.

The Key List may be created automatically or manually. An automatic process could be based on queries of a database containing the names of products or services. For example, the most popular products in the database could be listed by name, each name forming a Key Element and being associated with one or more address identifiers 4.2.

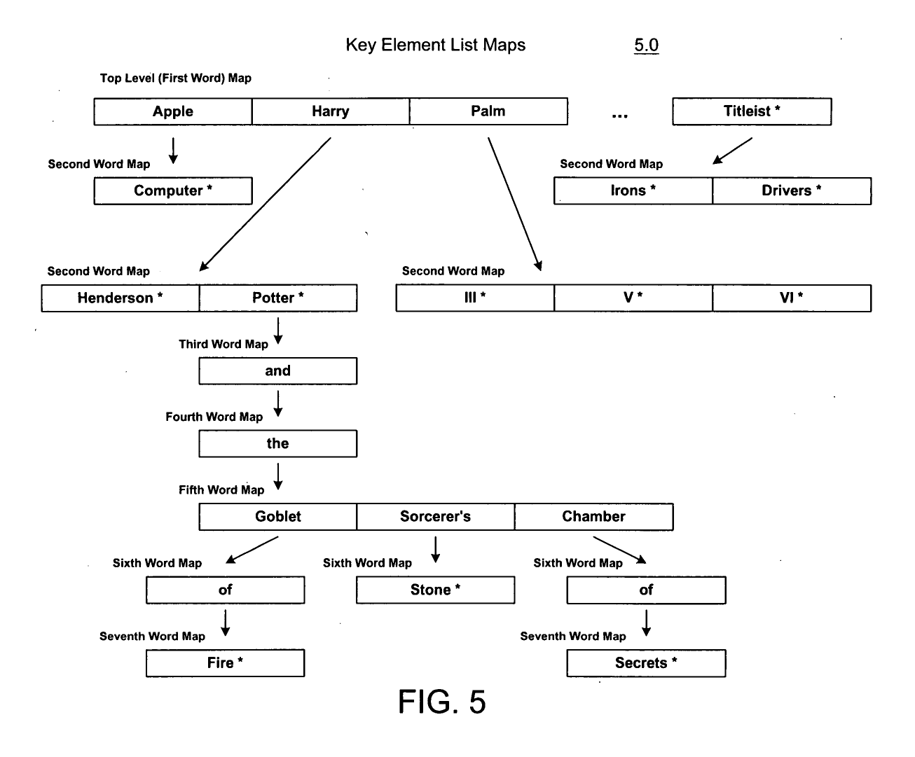

FIG. 5 shows to an example mapping process 15.0 using a hypothetical Key List 14.0. In this example, Key Elements represent predefined proper noun phrases. The mapping schema of FIG. 5 may be carried out using a hashtable where the keys are unique proper noun phrases, and the values are the associated id values. In order to find occurrences of the proper nouns in a document, the document is first split into an array of all its words. The first word is then checked against the hashtable. If a match is found, the proper noun is stored in a results array for later retrieval. The second word is then appended to the first word with a delimiting space, and that string is then checked against the hashtable. If a match is found, the string is added to the same results array. That process is repeated for the maximum length of a proper noun phrase, in this case 10 words. Once the maximum of 10 words is reached, if the results array is non-empty the last (and thus longest) string is kept as a final match.

The same 10-string matching process is then repeated, starting with the word following the string that was a final match if it existed, otherwise the word following the original starting word.

In addition, appendix A shows an optimization to the above algorithm by introducing a first-word hashtable that is used to directly bypass the first word in a list of 10, if said word is not a first word of a proper noun phrase. The first-word hashtable can also be merged with the hashtable of proper noun phrases to slightly reduce memory usage at the expense of some speed.

The output of the Recognizer 20 is sent 20.10 to the Annotator Module 30. The output of the Recognizer 20 would typically include data that relate the position of a Key Element identified on an electronic document. The output may also include data for the corresponding identifier for the Key Element. Using the Key Element data and corresponding Key List data, the Annotator Module 30 inserts 30.02 into the electronic document appropriate codes for the identifier so that Key Elements in the document are associated with their corresponding identifier.

Determining the position of a Key Element in a section of a web document for highlighting may easily be accomplished using standard programming practices. For example, the first position of a character in a string may be designated “Index Zero”. The Recognizer program module starts at Index Zero and adds one for each character it passes. The Annotator 30 determines from memory all the positions within a document where Key Elements were identified and introduces a URL or executable code corresponding to the address identifier for the Key Element 5.1. The resulting hyperlink may be introduced so that on a user's display, it visibly coincides with the Key Element. Alternatively or in addition to the foregoing, the hyperlink may be created so that it is otherwise closely but not necessarily directly associated with the Key Element. For example, the hyperlink could be associated with a graphic image positioned adjacent the Key Element. In such a case the presentation of the Key Element could be left in its native form on the document, the user understanding from the graphic image that a hyperlink is associated with the Key Element.

In addition to insertion of an associated URL, the Annotator may also attach scripts, executable code, additional hyperlinks, and formatting. The insertion of formatting tags or scripts is particularly useful to call a user's attention to the Key Element and to distinguish the associated hyperlink from existing, native hyperlinks associated with the Key Element or from other hyperlinks on the document. Code, executable by browsers, such as Macromedia's Flash and Shockwave, JavaScript and machine executable code, such as Visual Basic and C++ programs, queries and macros could be embedded.

Each Key Element may be associated with a unique form of annotation. However, in one possible embodiment, some or all Key Elements are annotated with the same primary URL address. The primary address would further contain an identifier code 4.2 unique to the Key Element. The primary address would be a CCS 2 that looks up a URL or application, for example, associated with the identifier code, redirecting the user to the URL or a target document generated by the application.

After annotation, a target document may then be presented 30.04 to the user to enable a user to identify matching Key Elements on the document and select links to the information associated with the Key Element's identifier.

As part of the annotation process, the Annotator may not only create links associated with Key Elements but it preferably highlights 30.06 the Key Element partially or in its entirety, or some region or area in close association with the Key Element, in a manner that is perceivable by a user, so as to indicate that there is an information link associated with the Key Element. This serves to distinguish the annotated Key Elements from other content. The highlighting should also be distinguishable from hyperlinked material that may be native to the original electronic document. For example, to distinguish the hyperlinks that are native in the web document from those that are associated with Key Elements, the Annotator may add to the annotated Key Elements double underlining, bolding, color highlighting or another distinguishing feature to indicate that the Key Elements are associated with special hyperlinks. In addition to visual cues, audio cues may also be used to indicate annotation.

Once the Annotator 30 completes the process of annotating Key Elements on an electronic document, the document may be presented to the user again through, for example, the user's browser

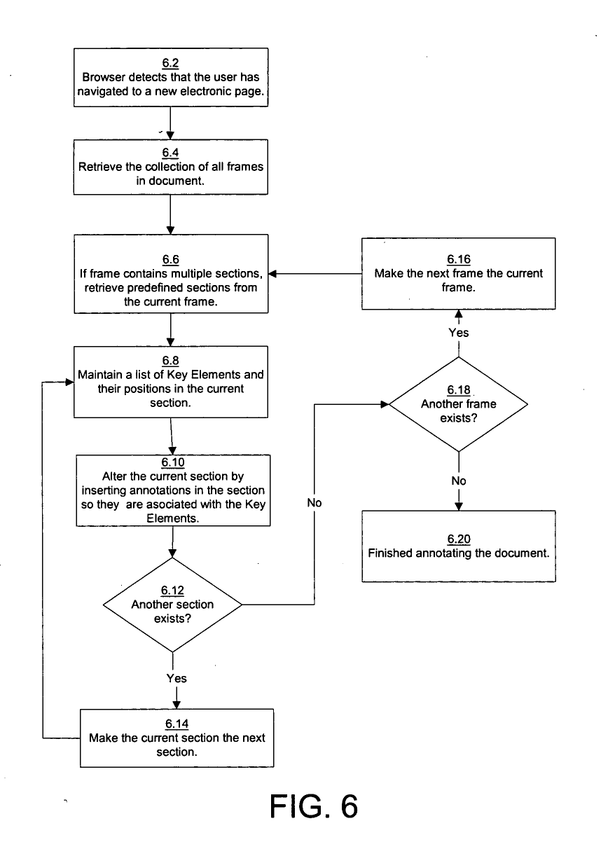

One possible embodiment 6.0 for methods of Recognizer 20 and Annotator 30 is shown in FIG. 6. In this example, which is largely implemented on a client computer system 3, an HTML web page and an Internet Explorer browser are used for illustrative purposes, although the invention is not limited to these possible features. The Recognizer 20 is invoked once a new document is detected 6.2. For example, the user's browser, e.g., Internet Explorer, informs a Browser Helper Object (discussed in detail below) that embodies the Recognizer that the user has navigated to a new electronic page, e.g., an HTML web page. The Recognizer then retrieves 6.4 some or all HTML sections that would be visible to a user. If frames are present, they are preferably retrieved one-by-one. The first frame is the “current frame”. Within a frame, the Recognizer retrieves 6.6 predefined sections of the document, according to HTML tags that code for a kind of section. The predefined sections would generally be those that are likely -to contain Key Elements. In an HTML document, these may include paragraphs, table cells, and line items, among other things. A first retrieved section is designated as the “current section”.

As the first section is parsed, a list of Key Elements and their positions in the current section is created and maintained 6.8. The Key Elements are identified through the Key List, and then the identified Key Elements are annotated 6.10 by the Annotator 30-(e.g., by insertion of a URL and identifier). Once the current section is annotated, the Recognizer determines 6.12 whether a second section meeting predefined criteria exists on the document. If so, the second section is made 6.14 the current section, and steps 6.8 to 6.14 are repeated until no additional section is found. If no additional section is found, the method returns to step 6.18 to determine if another frame exists. If another frame exists, it is made 6.16 the next current frame, and the method returns to step 6.6. If no additional frame exists, the method is finished 6.20 annotating the document. It is possible that one or more separate processes or threads may be used to allow simultaneous recognition and annotation for multiple sections (or frames). After the Annotator alters the original HTML, the annotated document is sent to a user interface, such as a browser, and rendered. Alterations may be made so quickly that the process is essentially invisible to users.

In the Linking and Retrieving module 40, which is really a set of operations involving user-interactions, a user may select 40.02 Key Elements that have been annotated on the electronic document. To select an annotated Key Element, the user may, using, for example, a pointing device such as a mouse, click on the annotated Key Element (hereinafter an annotated Key Element may be referred to as a “Smart Link”) to call for the information or execute code associated with the Smart Link. As indicated above, and discussed in further detail herein, this information or code may exist on the user's system or a remote server. It may be static information or information generated dynamically in response to the user's activation of the Smart Link. In addition to pointing devices, the link could be activated by other input means, including keyboards, touch pads, etc. It could also be activated by a user's voice command using existing technology for inputting, interpreting, and executing voice commands.

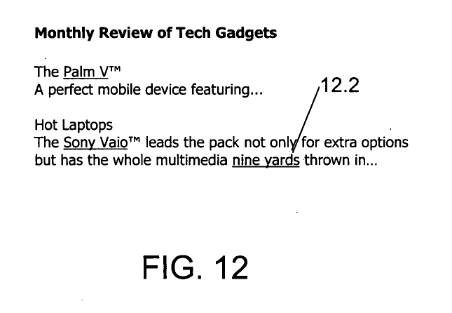

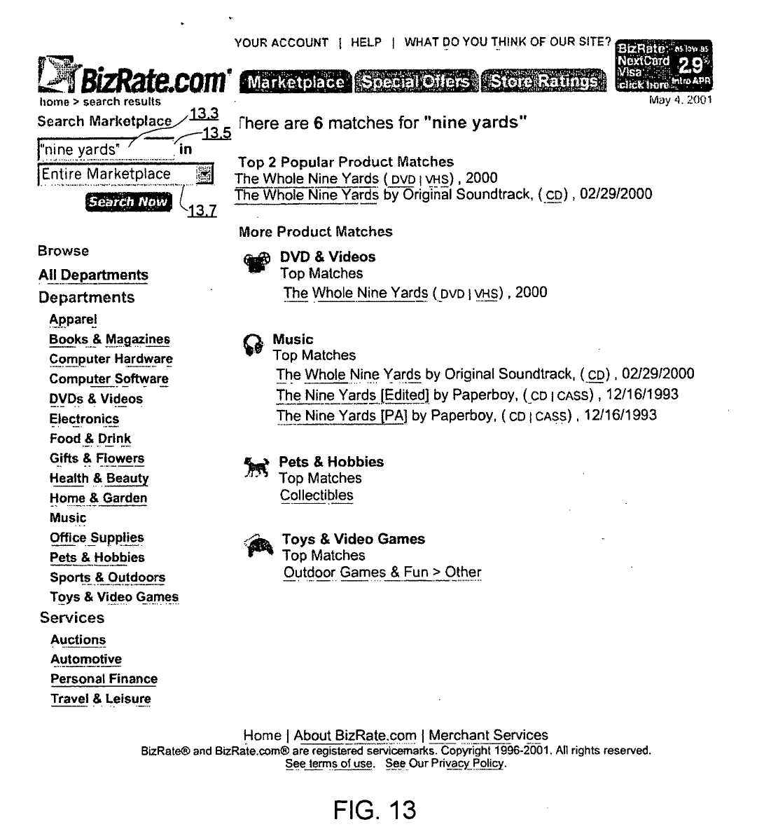

The selection of the Smart Link calls 40.04 sources of information associated with Key Element. The information may be provided through applications 40.06 invoked through a URL-identifier for a Key Element. One contemplated application is a search engine or other application that outputs information related to products related to a Key Element. In one embodiment, the output is comparative product information. It is contemplated that one possible form for delivering the information is a web page. For example, FIG. 12 is a document with Smart Links viewed from a browser. Activating the Smart Link “the whole nine yards” would send a query to the CCS, or another server, to search for product information related to this term. An example of information output is a document as shown in FIG. 13. The document is a web page with products related to the query term 13.3 “nine yards” organized by product category. The document includes links to the categorized products. It also includes interfaces 13.5, 13.7 for a user to input further search criteria. In other embodiments, the output could be a web page having other kinds of information related to a Key Element, or other documents associated with a URL 40.08 that is or corresponds to a Key Element identifier. The output could also be data objects 40.10, such as streaming media, files, or executable code associated with a Key Element identifier.

In FIG. 3, the presentation module 50 simply is the operation of presenting 50.02 the information that is called for by the activation of the Smart Link to a user's computer system through the computer's display systems. Typically, this would occur via the computer's browser or other application with a user interface. In addition to web pages, other electronic documents may be presented to a user. For example, information may be emailed to the user's system or another system. Information may otherwise be communicated to an output device by means known in the art, as called for by a user or settings or profiles for a user.

Where information is presented through the user's computer browser system, the information may be presented in the nature of a frame in an existing window or it may be presented through a newly opened browser or document or system window. While in the present invention, a web document, such as an HTML page is often be used as an example of an electronic document and a word or phrase the Key Element, other types of electronic documents may also be similarly treated by the present invention.

In addition to URLs and address identifiers, data in the nature of executable code may be used to annotate a Key Element. Activation of a Smart Link could invoke an application on a user's computer system or invoke delivery of code executable by the system. For example, the selection of Smart Link could invoke a program to inventory a user's system hardware or software. The results of the inventory could be used to identify new products or product upgrades that may be of interest to the user.

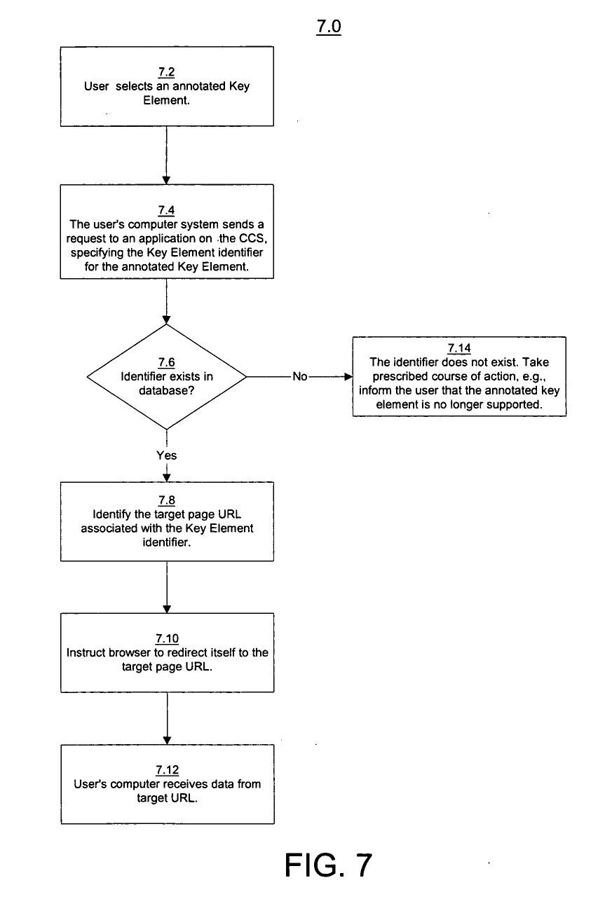

FIG. 7 shows one possible scheme for directing a user from a Smart Link to a “target document” associated with the Smart Link's Key Element. The target document may be a dynamic or static document presented by a server to a user's computer system. The process flow is generally as follows. A user selects 7.2 a Key Element that is annotated with a URL. The URL may designate an application, for example, a servlet on the CCS server. The user's web browser sends 7.4, for example, an HTTP request to the servlet on the CCS server specifying the Key Element or an identifier for the Key Element. The servlet determines whether the identifier for a Key Element is in the database. If the Key Element exists in the database, a URL associated with the identifier or Key Element is identified 7.8. The servlet may then instruct 7.10 the user's web browser to redirect to the target document. The user's browser or other applications on the user's computer system may then receive 7.14 data from the target URL. For example, the data could represent a web page that is displayed through the user's web browser. The data could also be other information 40.04, as indicated in FIG. 3.

If the Key Element or corresponding ID is not found 7.14, the user may be notified that the Key Element has expired. Alternatively, the Key Element may be submitted to an application for action. For example, the application could be a search engine that returns results to the user's computer that are related to the Key Element. Sub-address data included in the URL may designate the address identifier 4.2. The primary address is a server application that accepts as input the sub-address (data) for the URL.

As an example, the Annotator may modify an HTML document in the following manner:

Original Document HTML

<html>
<head>
</head>
<body>
<H1>Review of Tech Gadgets</H1>
The Palm V
A perfect mobile device featuring...
</p>
<p>
Hot Laptops
The Sony Valo ™ leads the pack not only for extra options but
has the whole multimedia nine yards thrown in...
</p>
...
</body>
</html>
© BizRate.com

Annotated Document

<html>
<head>
...
</head>
<body>
<H/>Review of Tech Gadgets</H1>
<p>
The <a style=text-decoration:overline
href=http://bizrate.com/servlet/com.bizrate.propern.Servlet.
InformationServer?noun-id=8788&aff-id=1”>Palm V ™</a> is
a perfect mobile device featuring...
</p>
<p>
Hot Laptops
Newly arrived, the <a style=text-deco ration:overline
href=http://bizrate.com/servlet/com.bizrate.propernoun.servlet.
InformationServer?noun-id=2397&aff-id=1”>Sony Vaio ™</a> leads
the pack not only for extra options but has the whole multimedia <a
style=text-decoration:overline
href=http://bizrate.com/servlet/com.bizrate.propernoun.servlet.
Information Server?noun-id=3875&aff-id=1”>nine yards
</a> thrown in...
</p>
...
</body>
</html>

© BizRate.com

In the foregoing example, the Key Elements were annotated “Palm V”, “Sony Vaio”, and “nine yards”. In each case, the Key Element was annotated with an identical URL “http://bizrate.com/servlet/com.bizrate.propernoun.servlet. InformationServer”. However, for each Key Element, the URL had unique sub-address data, namely an identifier (“noun-id”) “8788”, “2397” and “3875”, respectively. The identifier 3875 instructs a search engine to form a search engine query using the phrase “nine yards”.

As an alternative or in addition to directly modifying an original HTML document during the annotation process, a new and separate page may instead be created. Such a page may list Smart Links generated from Key Elements found in the original document and not content or data from that document. The new page may appear as a smaller “pop-up” window superimposed over the original document. Programming techniques for creation of a pop-up window or similar windowing or framing are well within the skill of persons in the art.

### EXAMPLE 1

### Client-Based Annotation

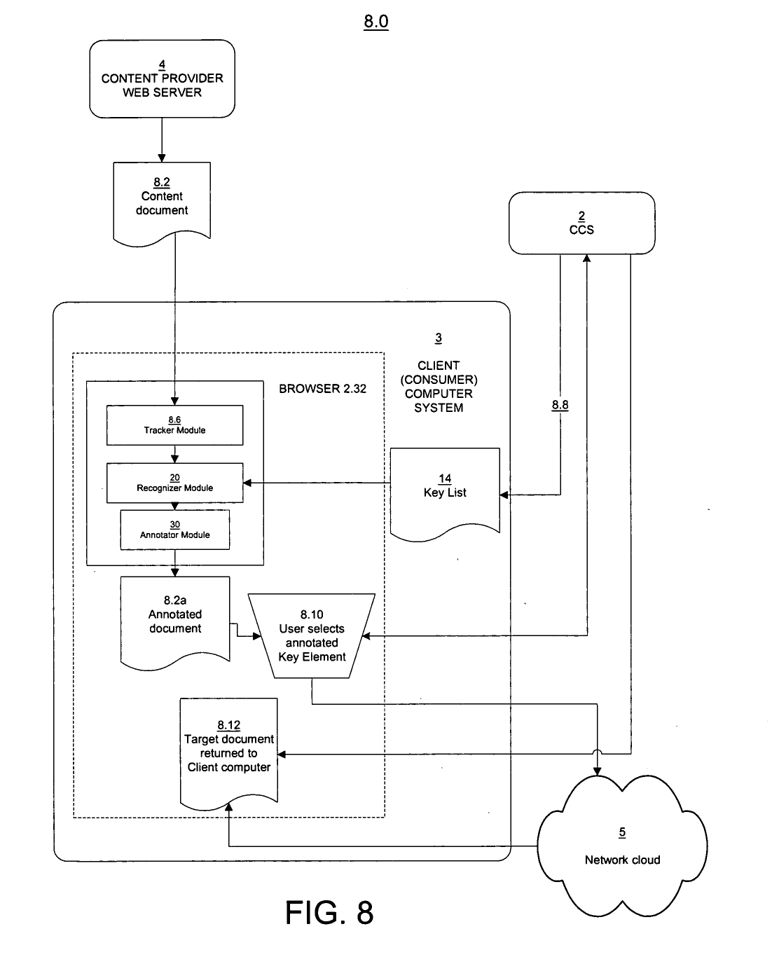

FIG. 8 shows an overview of functions associated with a client-server computer system 8.0, with the client computer system 3 (“Client”) implementing certain recognition and annotation modules. In particular, the Client hosts the Recognizer 20 and/or Annotator 30 Modules. These programs may be installed on the Client from a download, CD-ROM, or other means of application installation

Typically, a content provider 4 will serve an electronic content document 8.2 via a server to a user's browser 8.4. Typically, this would be a web document. The web document is passed to the Recognizer by a tracking application or module that monitors the Client for newly loaded web pages. The tracking function may be referred to herein in as a “Tracker” 8.6. The recognition and annotation functionality for this embodiment is in accordance with the earlier descriptions of the Recognizer 20 and Annotator 30. After recognition functions are performed by the Recognizer, annotation instructions are sent to the Annotator. In conjunction with the recognition and annotation functions, the client stores a Key List and a list of identifier URLs, if the identifier does not consist of a URL. Before the Client receives the content document 8.2 from a content server 4, the CCS 2 may initially serve 8.8 the Client an original or updated Key List 14, or URL identifier list, for use with the Recognizer 20 and Annotator 30. Preferably the lists are stored on the Client so that little or no interaction with a server is necessary in the annotation and recognition process on the Client. This accordingly allows the Recognizer and Annotator to operate at a local level on the Client. This is advantageous in its efficiency and independence from the server. For example, with a current Key List stored on the Client, the Client may annotate and recognize without delays or interruptions due to slow connection speeds to the CCS, failed connections, or CCS downtimes.

After a user selects 8.10 an annotated Key Element on the annotated document 8.2a, a target document 8.12 may be provided by the CCS server to the Client; however, this is just an example. Target documents may also be returned from World Wide Web servers or other networked systems 5. The document may be delivered by any computer system dictated by the identifier for a Key Element.

In one possible embodiment of the present invention, one or more Browser Helper Objects (“BHOs”) may be used to manage and embody the Key List, tracking, recognition and/or annotation features of the present invention on the Client system. As background, a BHO allows components to be created that are in-process Component Object Model (COM) components that Internet Explorer will load each time it starts up. Such objects run in the same memory context as the browser and can perform any action on the available windows and modules. For example, a BHO could detect the browser's typical events, such as “GoBack”, GoForward, and DocumentComplete”; access the browser's menu and toolbar and make changes; create windows to display additional information on the currently viewed document; and install hooks to monitor messages and actions. Further details about BHOs are not necessary, as they are well appreciated by persons skilled in the art, and design and implementation details may be readily obtained, for example, through Microsoft's website at www.microsoft.com.

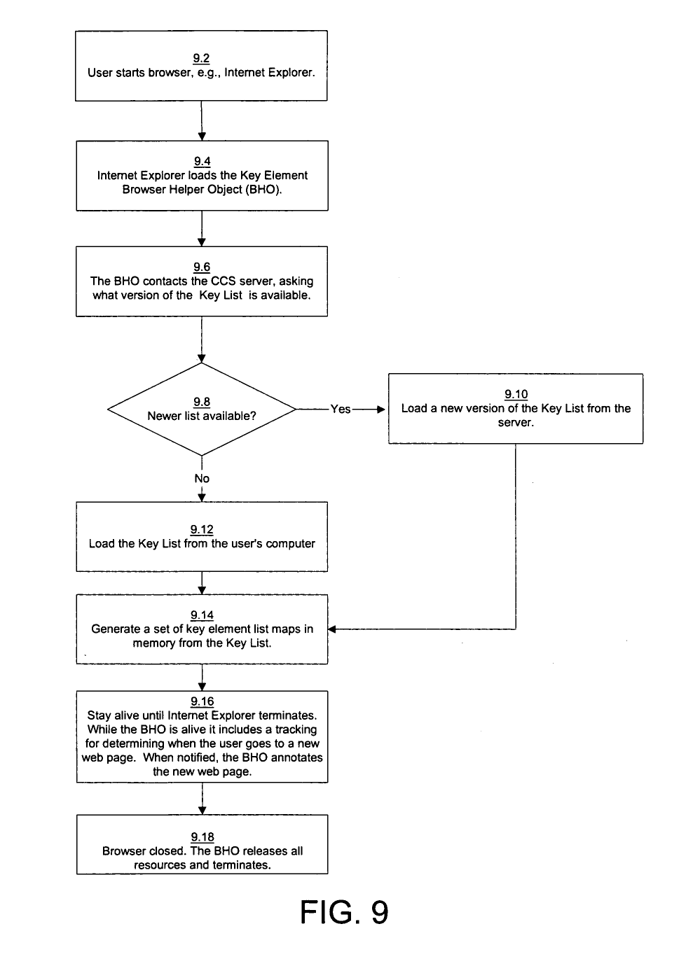

FIG. 9 shows a flow diagram of the lifecycle 9.0 of a BHO for use in implementing a possible embodiment of the Client system of FIG. 8. In this example, the browser is a version of Internet Explorer. A BHO is implemented 9.2 when a user starts Internet Explorer. Internet Explorer then loads 9.4 the BHO that communicates with a server containing a Key List. For example, the server may be the CCS 2. The BHO contacts 9.6 the server and determines 9.8 whether a more current version of the Key List is available. If a more current version is available, the server may upload 9.10 the list to the Client and may save the list on the Client's hard drive. If it is determined 9.12 that a list is not more current, then the existing list on the Client may be used. A set of Key Element list maps may then be generated 9.14 in memory from the Key List. For example, in the case of Key Elements consisting of proper noun phrases, the maps contain the words to make up the phrases. The BHO stays alive until the browser application is terminated. Each time the user goes to a new document during a session, the Annotator and Recognizer Modules described in FIG. 8 may be invoked to annotate the web document. Once Internet Explorer terminates 9.16, the BHO may release all resources and terminate.

Appendix C attached hereto shows example source code for implementing a system for recognition and annotation entirely on the client system.

### EXAMPLE 2

### Server-Based Annotation

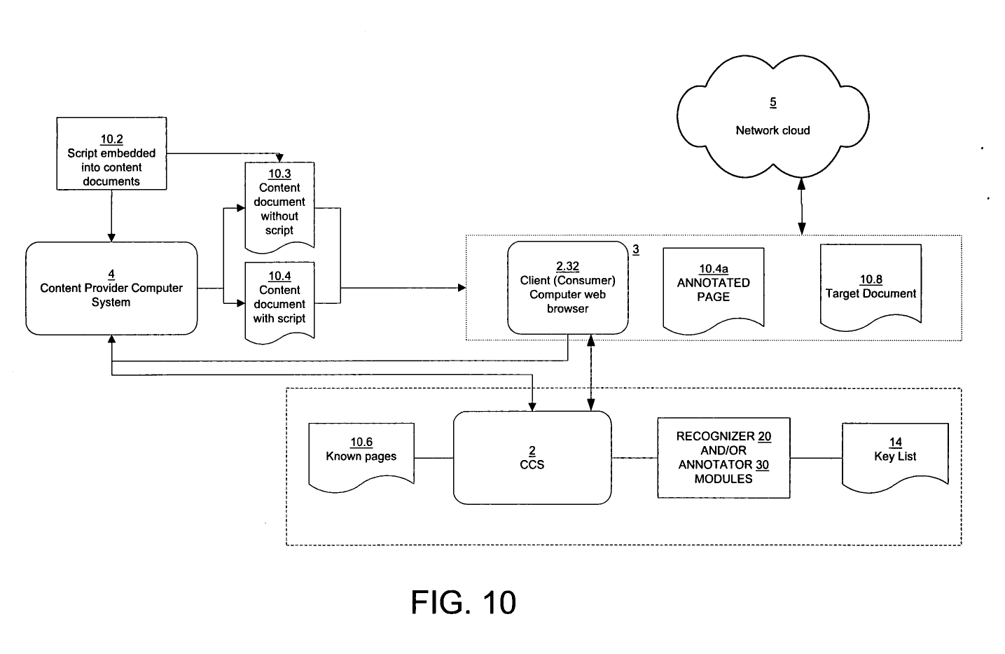

FIG. 10 shows an overview of a system 10.0 wherein the Recognizer 20 and/or Annotator 30 Modules are executed in whole or part on a central computer system (“CCS”) 2. However, some functions may be performed on the client side so that the overall annotation and recognition functions are not necessarily entirely based on the CCS. In this system, a document 10.4 from a content provider includes certain instructions, in the nature of, for example, scripts with annotation or recognition functionality that may be executed by the client system receiving the document. Alternatively, or in conjunction therewith, document 10.4 may include an address on a CCS or another computer that the client system calls to after executing instructions on document 10.4. In response, the CCS returns to the client system annotation and/or recognition scripts and/or data executable or usable by the client system to perform recognition or annotation functions.

The scripts, being executable by the client, provide recognition or annotation functionality to the client side. Typically, the receiving computer system would be a consumer's computer system 3. A content provider 4 hosts the content pages with the embedded script. The script would typically be provided to the content provider by, for example, an administrator of the CCS 2, or otherwise made available to content providers. The content providers may then embed 10.2 the scripts in selected content documents. Alternatively, as indicated in block 10.2, the scripts or address for scripts may be added to a content document 10.3 without scripts at some point between the content provider computer system and the client computer system. This may be done by an intermediary system that sits between the content provider and client. In one possible embodiment, the scripts are added by the Internet service provider that serves as a conduit or provides a cache in the transfer of the document. Once received by the browser system of a client, the script may call for all recognition and annotation functions to be performed by the Client, as in the case of the embodiment of FIG. 8. Alternatively, the scripts may call for certain functions to be performed by the CCS 2.

As an example, the Recognizer may scan a document employing the code listed in Appendix A. This module functions mainly to identify Key Elements in a document. As noted above, the functions of the module may be distributed over more than one system. In one possible embodiment, after document 10.4 is received by a client computer system 3, a script on the document is executed and instructs the CCS to retrieve the corresponding document. Typically, the document would be retrieved from the content server 4 that served the document 10.4 to a user. Alternatively, it may be retrieved from the CCS or another site that stores the same document. In addition, the CCS may store known pages 10.6 so that it does not need to retrieve pages from content server 4 or another remote system. The known pages may be stored in pre-annotated condition for delivery to a client's computer system 3. If the document 10.4 that is called for has not been previously annotated, the Recognizer 20 on the CCS 2 would recognize the document Key Elements. A Key List 14 may be maintained on the CCS 2 for this purpose. After recognition, the CCS may annotate the document and return it to the user's computer system. The CCS may also send the annotation data and instructions to the user's computer 3 for annotation there. A suitable language for scripting the Annotation functions on the client is JavaScript. Appendix B lists JavaScript code suitable for implementing annotation functions on the client system 3. Alternatively, the instructions may be sent to a different computer and an annotated document served back to the user's computer from there.

As with the other embodiments described herein, a user may select an annotated Key Element to retrieve a source of data or information. For example, in FIG. 10 target document 10.8 could be retrieved from the CCS 2 or another network 5 source, such as a World Wide Web based system, or any other computer system in communication with the client computer system.

### EXAMPLE 3

### Product Search System

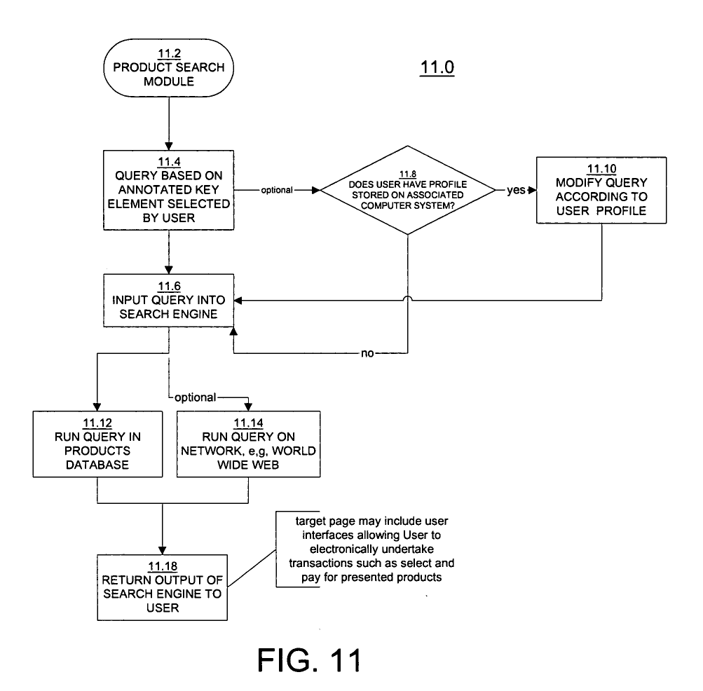

A Key Element in the present invention may be used to formulate input for a search engine. FIG. 11 shows a system 11.0 for searching. In one possible embodiment, the Key Element is a word or phrase that may be used as the basis for a query of, for example, a database 11.4 or distributed system of files or documents 11.6. FIG. 12 represents an example of a web page with a Key Element 12.2 that is annotated and highlighted. The Key Element is the phrase “nine yards”. The Key Element annotation includes a URL to a search engine. A selection of the annotation 12.2 forms a query 11.4. For example, a word or phrase comprising, derived from or otherwise associated with the Key Element is sent to a search engine associated with the Key Element URL annotation. In the example, the query phrase is “nine yards”. The search engine receives and inputs 11.6 the data and queries 11.12, 11.14 the source containing searchable data. In a preferred embodiment of the present invention, a database 6 contains a plurality of data items comprising products and associated attributes for each product. The database may be maintained on or coupled to CCS 2. If a user has a profile or settings stored on the same or another database logically coupled to the products database, the user profile settings may also be used 11.8 as a basis for a query of the products database. The query may be modified 11.10 according to the user's profiles and settings. For example, the profile could screen products based on the user's age, location, interests, prior product purchases, delivery and fulfillment preferences, etc. After input and running of the query 11.4, the search system may output 11.8 a set of results. The results may be information related to products that match the search query to some predetermined degree. The results are returned 11.18 to the user. FIG. 13 shows an example target document with output from a search engine, generated in response to a user's selection of the annotated Key Element “Nine Yards”.

FIG. 13 is a web document that contains information about products or product-related information, related to the Key Element “Nine Yards”. Preferably, the document includes links to further information or services related to the output results. The document may also be associated with means for the online purchase products or services, the means could be an online purchase form embedded in the document or a link to another document with a form for online purchasing of a product. The online purchase forms may be programmed using standard programming practices known to persons skilled in the art.

The output of the search engine need not be returned to the same computer where the user selected an annotation. It may be returned to another computer system or another output device associated with the user and/or the user's original computer. In addition to, or instead of database queries, the system may use similar principles to search 11.14 for product information in web pages on the World Wide Web or other sources searchable over a network 5.

In both client and server based systems, instead of or in addition to an annotation link to the product search engine, the link could be to an online merchant or other target or system that is related to a Key Element.

Administrative Features for a Central Computer System

The CCS may include one or more of the following administrator resources:
Administrator resources that allow an administrator of the CCS, or a party authorized by the administrator, to post content or input data to the CCS or computer systems associated with the CCS. For example, a content provider may wish to provide selected content documents for recognition or annotation or for embedding of scripts related to the foregoing functions.
Administrator resources for setting access permissions, security procedures, and access procedures for participating parties.
A List Manager, which is a database tool that, under the direction of humans, maintains the Key List. The List Manager may be, for example, a Java Swing application and requires the installation of the Java 1.2 (or higher) Runtime Environment. The List Manager may run on any operating system platform that supports Java. CCS administrators use the List Manager to run periodic list updates on a category-by-category basis. Category managers for different products, could, for example, edit and delete list items and update procedures. The List Manager may run on any hardware that supports Java, for example. The List Manager should allow administrators enough autonomy to create new updates, foray into new categories, change destination URLs, scripts, etc.
Authoring tools that allow content providers to embed recognition or annotation scripts in their content documents.

The foregoing embodiments are for illustrative purposes and are not intended to be limiting. Persons skilled in the art are capable of appreciating other embodiments from the scope and spirit of the foregoing teachings and appended claims.

1. In a system comprising a content provider computer system, a central computer system, and a client computer system, a method comprising:
in an electronic content document retrievable from a content provider computer system storing content documents, embedding code executable by a client computer to invoke the central computer system to recognize key elements on a document corresponding to the content document;
recognizing key elements in the document; and
generating annotation instructions for the client computer system to create one or more annotations for one or more key elements in the content document and sending the instructions to the client computer system.

2. The method of claim 1, wherein the code embedded into the content document is embedded by a computer system under the control of the party controlling the content provider computer system.

3. The method of claim 1, wherein the code embedded into the content document is embedded by computer system under the control of the party controlling the central computer system.

4. The method of claim 1 wherein, the code embedded into the content document is embedded by a party controlling a computer system associated with the Internet service provider for the client computer system.

5. The method of claim 1, wherein the annotation for a key element is associated with data (“key element data”) that is suitable for forming a query for use by a search engine to locate information related to the key element.

6. The method of claim 5, further comprising using the key element data to query a database of a computer system remote from the client system, the key element data being sent to the remote computer by the client computer system, following a user's selection of the annotation.

7. The method of claim 6, wherein the search is adapted to find information about products relating to the key element associated with the annotation.

8. The method of claim 7, wherein product-related information responsive to the query is returned to the user selecting the annotation.

9. The method of claim 7, wherein the product-related information is in the nature of at least one of (i) comparative product information and (ii) products listed by production.

10. The method of claim 7, wherein the information is provided in a target document that includes means for a user to electronically retrieve additional information about a listed product.

11. The method of claim 7, wherein the target document is associated with means for making an online purchase of a listed product.

12. The method of claim 1, wherein the key element data associated with the annotation corresponds to the URL for a static document available over the Internet.

13. The method of claim 1, wherein following a user's selection of an annotation key element data is sent to a remote computer system, the remote computer system uses the data to dynamically generate data comprising a data object for sending to the client computer system.

14. The method of claim 13, wherein the data object comprises streaming media.

15. The method of claim 13, wherein the data object comprises computer code executable by the client computer system.

16. The method of claim 1, wherein the recognizing occurs on the central computer system.

17. The method of claim 16, wherein the annotation instructions are generated on the central computer system.

18. The method of claim 1, wherein the annotation instructions direct the creation of a hyperlink in association with a key element.

19. The method of claim 1, wherein the annotation instructions direct the creation of a pop-up window with links to information related to a key element recognized by the recognizer.

20. In a system comprising at least two computer systems, a method comprising:
on a first computer system, receiving over a packet-switched network a web page, the web page corresponding to a web page presented to the user of a second computer system;
on the first computer system, recognizing in the web page one or more predetermined key elements comprising one or more words relating to one or more products; and
sending annotation instructions from the first computer system to the second computer system for use in creating annotations on the web page presented on the second computer.

21. The method of claim 20, wherein each key element has a corresponding identifier that corresponds to a URL, and the annotation for a key element includes key element data for forming a search query, the data being transmittable to a computer system with a search engine upon user selection of an annotated key element.

22. A method comprising sending a key list from a remote computer system to a client computer system, the client computer having executable code for performing one or both of annotation and recognition of key elements on the key list, the key list comprising a set of key elements and corresponding identifiers; and the key list being adapted for the client computer to use in performing on an electronic document presented to a user of the computer system from a content provider computer system one or more of (i) recognizing key elements and (ii) annotating key elements.

23. The method of claim 22, wherein the code includes means for key elements to be associated with a hyperlink to information related to a key element on the electronic document.

24. The method of claim 22, wherein the code includes means for key elements to be associated with a pop-up window displaying at least one link to information related to a key element on the electronic document.

25. The method of claim 22, wherein the electronic document is a web page sent over a packet-switched network.

26. The method of claim 22, wherein the client computer system has code for performing both annotation and recognition of a web page received from a content provider.

27. In a system comprising at least a content provider computer system and a consumer computer system, a method comprising:
on a first computer system, receiving an electronic document with at least one predetermined key element;
from a second computer system, knowing the identity of the electronic document received on the first computer system, sending instructions to the first computer system for presenting to the user of the first computer system one or more hyperlinks related to a key element on the electronic document so the user may retrieve data or information related to the key element.

28. The method of claim 27, wherein the instructions to the first computer system are usable by that system to annotate the electronic document with data corresponding to an identifier for to a key element.

29. The method of claim 27, wherein the electronic document includes code executable by a second computer system to generate annotation instructions that are sent to the first computer system for use in generating the hyperlink.

30. The method of claim 29, wherein the electronic document is a web page, and prior to being received by the first computer system, a code executable by the first computer system is embedded in the web page, the code being capable of invoking the second computer to generate annotation instructions for the first computer system.

31. The method of claim 30, wherein the code is executable by the second computer to retrieve a web page corresponding to the one received on the first computer system, the second computer recognizing predetermined key elements on the web page and sending annotation instructions to the first computer system for annotation of the web page on the first computer system.

32. The method of claim 29, wherein the code is embedded in the electronic document by a computer system of an Internet service provider that serves as a conduit for the electronic page received by the first computer system.

33. In a system comprising at least two computer systems, a method comprising:
from a first computer system, providing a second computer system a set of predetermined key elements and corresponding identifiers for use in creating annotations for key elements on an electronic document;
receiving from the second computer system data associated with an annotation for a key element (“key element data”) following selection of an annotation by a user of the second computer system;
retrieving or generating data or information responsive to the key element data received from the second computer system; and
sending the information to a computer system or output device associated with the user selecting the annotation.

34. The method of claim 33, wherein the key element data is suitable for forming a query for use by a search engine to locate information related to the key element, the key element data being transferred over a packet-switched network to another computer system.

35. The method of claim 34, wherein the information relates to products relating to the key element.

36. The method of claim 35, further comprising using the key element data to formulate a query in a database coupled to the other computer system and sending product-related information generated from the query to the user selecting the annotation.

37. The method of claim 36, wherein the product-related information includes products listed by product category.

38. The method of claim 36, wherein the product-related information includes comparative product information.

39. The method of claim 36, wherein the information is provided in a target document that includes means for a user to electronically retrieve additional information about a listed product.

40. The method of claim 39, wherein the target document is associated with means for making an online purchase of a listed product.

41. The method of claim 33, wherein the key element data comprises the URL for a static document available over the Internet.

42. The method of claim 33, wherein the key element data is used to dynamically generate data comprising a data object for sending to the second computer system.

43. The method of claim 42, wherein the data object comprises streaming media.

44. The method of claim 42, wherein the data object comprises computer code executable by the second computer system.

45. A method for use on a system of networked computers, comprising:
from a first central computer system, transmitting to a second computer system of a consumer code executable on the consumer computer system for (i) recognizing predetermined key elements on an electronic document and (ii) annotating the key elements by associating recognized key elements with a URL for a second computer system computer system, the address being determinable from a key list comprising a set of key elements and corresponding identifiers.

46. The method of claim 45 wherein the code is executable to recognize and annotate key elements on a web page received from a content provider computer system.

47. The method of claim 46, wherein one or more key elements comprise one or more words.

48. A computer code stored in memory on a central computer system and executable thereon, the code being invokable on the central computer system by a client computer system to generate annotation instructions for the client computer system to associate annotations with key elements on an electronic page received by the client computer system from a content provider computer system.

49. A computer code stored in memory on a first computer system comprising the computer of a consumer and executable thereon, the code being adapted to (i) recognize predetermined key elements on an electronic document received from a content provider computer system, and (ii) create an annotation for a key element by associating recognized key elements with an identifier corresponding to the address of a second computer system computer system, the identifier being determined from a set of key elements and corresponding identifiers stored on the first computer system.

50. The computer code of claim 49, wherein the code is adapted to recognize and annotate an electronic document comprising a web page received by the first computer system from a content provider over a packet switched network and the code uses a key list comprising the set of key elements and identifiers, the identifiers corresponding to one or more URLs.

51. The computer code of claim 50, wherein the code is adapted to recognize and annotate the web page using a key list with at least one key element comprising one or more words.

52. The method of claim 51, wherein the code is adapted to retrieve a key list from a remote computer system

53. A computer system comprising:
a first computer system in networked communication with a plurality of other computer systems, at least one of which is a content server;
means in the first computer for receiving an electronic page with content from a content provider computer system storing content pages;
a key list stored on the system comprising a set of key elements and corresponding identifiers that correspond to addresses for electronic information or data that are relevant to a key element;
a recognizer module stored on the system for parsing a page received from the content provider computer system and identifying on the electronic page one or more listed key elements matching to predetermined key elements in the stored list;
an annotation module stored on the system for associating identified key elements with an annotation from the key list so that a user presented the electronic page can retrieve information related to the key element by selecting annotation.

54. A web document stored in memory on a server, the web document containing code executable by a client computer system enabling the client computer to invoke a remote computer system to generate annotation instructions that are returned to the client computer system, the annotation instructions being used by the client computer system to create an annotation for a predetermined key element on the web document.

55. The web document of claim 54, wherein the key element comprises one or more words.

56. The web document of claim 54, wherein the server is a content server.

57. The web document of claim 54, wherein the server is controlled by a party other than the party that is the source of the web document.

58. The web document of claim 54, wherein the server is controlled by the party controlling the Internet service provider that serves as a conduit for delivery of the web document to the client computer system.

59. The web document of claim 54, wherein the executable code comprises instructions directing the client computer system to access a URL for the remote computer system.
